(19) United States
(12) Patent Application Publication
(10) Pub. No.: US 2012/0022739 A1
(43) Pub. Date: Jan. 26, 2012

(54) ROBUST VEHICULAR LATERAL CONTROL WITH FRONT AND REAR CAMERAS

(75) Inventor: Shuqing Zeng, Sterling Heights, MI (US)

(73) Assignee: GM GLOBAL TECHNOLOGY OPERATIONS, INC., Detroit, MI (US)

(21) Appl. No.: 12/840,058

(22) Filed: Jul. 20, 2010

(51) Int. Cl. G06F 7/00; B62D 6/00; H04N 7/18

(52) U.S. Cl. 701/29; 348/148; 701/41; 348/E07.085

(57) ABSTRACT

A method and system for closed-loop vehicle lateral control, using image data from front and rear cameras and information about a leading vehicle's position as input. A host vehicle includes cameras at the front and rear, which can be used to detect lane boundaries such as curbs and lane stripes, among other purposes. The host vehicle also includes a digital map system and a system for sensing the location of a vehicle travelling ahead of the host vehicle. A control strategy is developed which steers the host vehicle to minimize the deviation of the host vehicle's path from a lane reference path, where the lane reference path is computed from the lane boundaries extracted from the front and rear camera images and from the other inputs. The control strategy employs feed-forward and feedback elements, and uses a Kalman filter to estimate the host vehicle's state variables.

### BACKGROUND OF THE INVENTION

1. Field of the Invention

This invention relates generally to a lateral control method and system for a vehicle and, more particularly, to a lateral control method and system for a host vehicle which uses image data from front and rear cameras, a digital map, and information about the position of a leading vehicle to enable closed-loop control of the host vehicle's steering in order to follow a lane reference path.

2. Discussion of the Related Art

Many modern vehicles include onboard cameras, which are used for a variety of purposes. One common application is a forward-viewing camera which can provide images to be used in a collision avoidance system, a lane departure warning system, a lateral control system, or a combination of these or other systems. However, conditions may arise which prevent a good image from being obtained from the forward-viewing camera. Such conditions include a leading vehicle at close range which blocks much of the camera's field of view, and low-visibility weather conditions, such as rain and fog, which obscure the camera's image. In such conditions, when a usable image from the forward-view camera is not available, systems which rely on the camera's image for input cannot be operated.

Meanwhile, many newer vehicles are also equipped with a rear-view camera, which is normally used only for backup assistance, such as providing a video image for the driver to see what is behind the vehicle. Although these rear-view cameras typically have a resolution and field of view which are more than sufficient for other image data collection purposes, until now they have not been used to supplement the images from forward-view cameras for lane position and lateral control applications.

There is an opportunity to use the image data available from a rear-view camera, and combine it with image data from a forward-view camera and other sensors, to provide a more robust lateral control system. The resultant two-camera system not only makes use of more input data under normal conditions, but also provides a usable source of image data to allow operation of the system when conditions are unfavorable for forward-view imaging.

### SUMMARY OF THE INVENTION

In accordance with the teachings of the present invention, a method and system are disclosed for closed-loop vehicle lateral control, using image data from front and rear cameras, a digital map, and information about a leading vehicle's position as input. A host vehicle includes cameras at the front and rear, which can be used to detect lane boundaries such as curbs and lane stripes, among other purposes. The host vehicle also includes a digital map system and a system for sensing the location of a vehicle travelling ahead of the host vehicle. A control strategy is developed which steers the host vehicle to minimize the deviation of the host vehicle's path from a lane reference path, where the lane reference path is computed from the lane boundaries extracted from the front and rear camera images and from the other inputs. The control strategy employs feed-forward and feedback elements, and uses a Kalman filter to estimate the host vehicle's state variables.

Additional features of the present invention will become apparent from the following description and appended claims, taken in conjunction with the accompanying drawings.

### BRIEF DESCRIPTION OF THE DRAWINGS

FIG. 1 is a block diagram of a vehicle lateral control system which uses front and rear cameras and other sources of input;

FIG. 2 is a diagram of a bicycle model for lateral control of a host vehicle;

FIG. 3 is a diagram of the host vehicle showing many of the key parameters of the lateral control model;

FIG. 4 is a control block diagram showing how the vehicle lateral control model is implemented;

FIG. 5 is a block diagram of a system for vehicle lateral control using a 2-camera lane fusion approach;

FIG. 6 is a block diagram of a first embodiment of a lane fusion system using input from two cameras;

FIG. 7 is a block diagram of a second embodiment of a lane fusion system using input from two cameras;

FIG. 8 is a diagram which shows an example of lane stripe representation for a scenario where several short stripes and one long arc have been detected;

FIG. 9 is a histogram which shows how the displacement of the host vehicle to the lane boundaries can be computed;

FIG. 10 is a flow chart diagram of the Kalman filter tracking method used in the lane tracking module of FIG. 7; and

FIG. 11 is a flow chart diagram of the particle filter tracking method used in the lane tracking module of FIG. 7.

### DETAILED DESCRIPTION OF THE EMBODIMENTS

The following discussion of the embodiments of the invention directed to a robust vehicular lateral control method using front and rear cameras is merely exemplary in nature, and is in no way intended to limit the invention or its applications or uses.

Many modern vehicles include forward-view cameras, and systems which use the image data from the forward-view cameras in applications such as lane departure warning and lateral control assistance. However, images from forward-view cameras can be obstructed by a leading vehicle, or obscured by sun glare, fog, rain, or snow, which reduces the reliability of applications which would rely on the images. Given the increasing availability of rear-view cameras, often used primarily for backup assistance, it makes sense to use the rear-view camera image data as a supplement to the forward-view camera image data. Along with GPS and digital map data, vehicle dynamics sensors, and radar-based or other systems capable of detecting a vehicle on the road ahead of the host vehicle, the forward-view and rear-view camera image data can be used in advanced applications for improved safety and vehicle control.

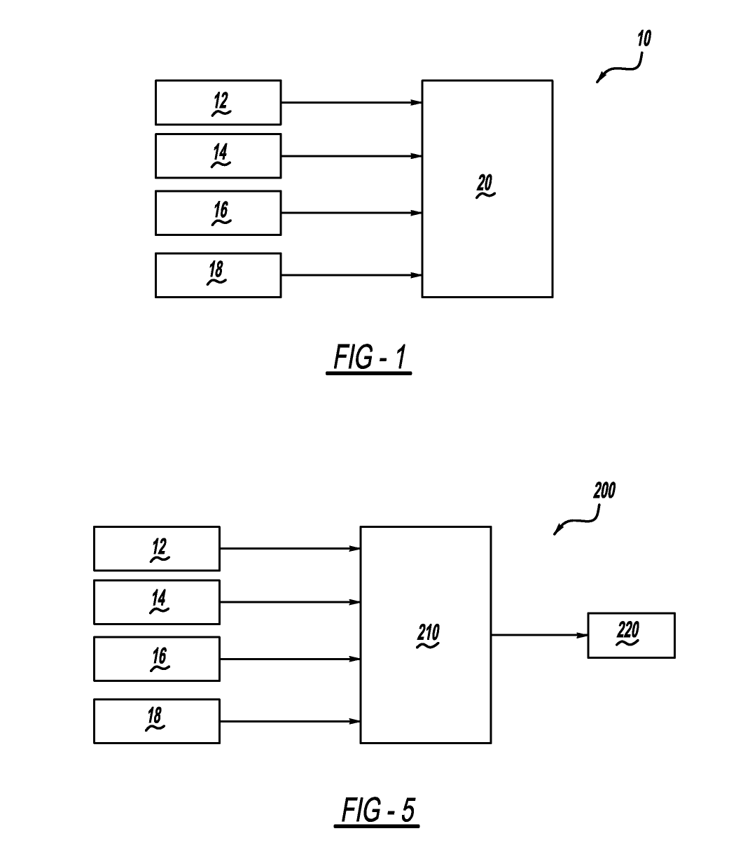

In one approach, the data sources are used directly in a vehicle lateral control application. FIG. 1 is a block diagram of a system 10 for lateral control of a vehicle using forward-view and rear-view cameras and other data sources. The system 10 uses image data from a forward-view camera 12 and a rear-view camera 14, as will be discussed below. A leading vehicle position system 16, which may be a long range radar (LRR) or other type system, tracks the position of a leading vehicle, for the purpose of estimating the path of the roadway. Road curvature information from a GPS-based navigation system or digital map 18 provides another source of data for the system 10. The inputs from the forward-view camera 12, the rear-view camera 14, the leading vehicle position system 16, and the digital map 18 are all used by a vehicle lateral control module 20, the operation of which will be discussed in detail below.

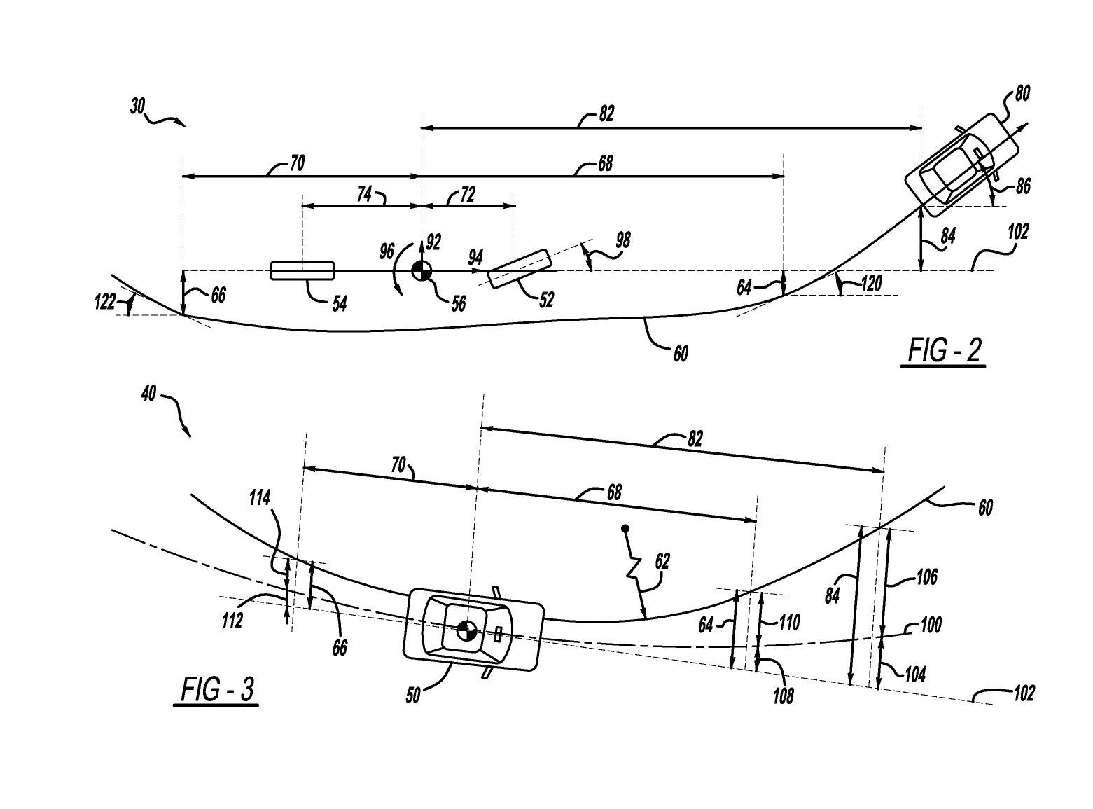

FIG. 2 is a diagram of a bicycle model 30 for vehicle lateral control, which is obtained by combining the two wheels of each axle into one wheel at the centerline of the vehicle. FIG. 3 is a diagram of a control model 40 which adds more detail to the bicycle model 30. Like elements and dimensions share the same reference numerals in FIGS. 2 and 3, which will be discussed together. The following table is provided as an index of the items and dimensions shown in FIGS. 2 and 3, including their reference numbers and descriptions.

| Ref # | Symbol | Description |
|---|---|---|
| 30 | n/a | bicycle model |
| 40 | n/a | control model |
| 50 | n/a | host vehicle |
| 52 | n/a | front tire |
| 54 | n/a | rear tire |
| 56 | n/a | center of gravity point |
| 60 | n/a | lane reference path |
| 62 | κ | lane curvature |
| 64 | Δy_{F} | front lateral displacement |
| 66 | Δy_{T} | rear lateral displacement |
| 68 | d_{F} | longitudinal distance in front of center of gravity |
| 70 | d_{T} | longitudinal distance behind center of gravity |
| 72 | l_{F} | distance of front axle from center of gravity |
| 74 | l_{T} | distance of rear axle from center of gravity |
| 80 | n/a | leading target vehicle |
| 82 | Xₒ | forward distance of leading target vehicle from |
| | | center of gravity of host vehicle |
| 84 | Yₒ | lateral distance of leading target vehicle from |
| | | center of gravity of host vehicle |
| 86 | θₒ | heading angle of leading target vehicle with |
| | | respect to host vehicle |
| 92 | ν_{yH} | host vehicle lateral velocity |
| 94 | ν_{xH} | host vehicle longitudinal velocity |
| 96 | ω_{H} | host vehicle yaw rate |
| 98 | δ_{F} | front wheel steering angle |
| 100 | n/a | vehicle path |
| 102 | n/a | heading line |
| 104 | αₒ | lateral offset between the heading line and the |
| | | vehicle path at forward distance 82 |
| 106 | εₒ | lateral offset between the vehicle path and the lane |
| | | reference path at forward distance 82 |
| 108 | α_{F} | lateral offset between the heading line and the |
| | | vehicle path at forward distance 68 |
| 110 | ε_{F} | lateral offset between the vehicle path and the lane |
| | | reference path at forward distance 68 |
| 112 | α_{T} | lateral offset between the heading line and the |
| | | vehicle path at rearward distance 70 |
| 114 | ε_{T} | lateral offset between the vehicle path and the lane |
| | | reference path at rearward distance 70 |
| 120 | θ_{F} | vehicle orientation angle with respect to tangent to |
| | | lane reference path at forward distance 68 |
| 122 | θ_{T} | vehicle orientation angle with respect to tangent to |
| | | lane reference path at rearward distance 70 |

A host vehicle 50 is the subject of the bicycle model 30 and the control model 40, used in the vehicle lateral control module 20. The host vehicle 50 is represented by a front tire 52, a rear tire 54, and a center of gravity point 56 in the bicycle model 30. The host vehicle 50 is assumed to be equipped with a yaw rate sensor (not shown), and other sensors as necessary to know its longitudinal and lateral velocity.

A lane reference path 60 is assumed to be the centerline of a circular lane path with curvature ic, an estimate of which comes from the digital map 18. For the augmented lateral control system as considered in the bicycle model 30, the lateral displacement of the host vehicle 50 from the lane reference path 60 is measured both as a front lateral displacement Δy_{F} and a tail lateral displacement Δy_{T} by the forward-view camera 12 and the rear-view camera 14, respectively. The displacement measurements are acquired by the cameras at a longitudinal distance d_{F} in front of the center of gravity point 56 and a distance d_{T} behind the center of gravity point 56. The distances d_{F} and d_{T} are time variant and dependent on the quality of lane markers detected by the cameras 12 and 14, occlusion by leading or following vehicles, and lighting conditions.

The leading vehicle position system 16 onboard the host vehicle 50 can detect a leading target vehicle 80, and provide its longitudinal distance X_{O}, lateral distance Y_{O}, and heading angle θ_{O}. Only a vehicle immediately in front of the host vehicle 50 and within a distance threshold (e.g., 50 m) is considered as the leading target vehicle 80. Other vehicle parameters in the bicycle model 30 are distances l_{F} and l_{T} of the front and rear axles, respectively, from the center of gravity point 56. Three host vehicle state variables are also shown: vehicle lateral velocity v_{yH} vehicle longitudinal velocity v_{xH}, and vehicle yaw rate ω_{H}. A front wheel steering angle δ_{F} is the input of the automatic steering system as commanded by the lateral control system 20.

A vehicle path 100 describes the path the host vehicle 50 is currently following, and a heading line 102 represents a straight line through the centerline of the host vehicle 50. Distance α_{O} is the lateral offset between the heading line 102 and the vehicle path 100 at the forward distance X_{O}. Distance ε_{O} is the lateral offset between the vehicle path 100 and the lane reference path 60 at the forward distance X_{O}. Distance α_{F} is the lateral offset between the heading line 102 and the vehicle path 100 at the forward distance d_{F}. Distance ε_{F} is the lateral offset between the vehicle path 100 and the lane reference path 60 at the forward distance d_{F}. Distance α_{T} is the lateral offset between the heading line 102 and the vehicle path 100 at the rearward distance d_{T}. Distance ε_{T} is the lateral offset between the vehicle path 100 and the lane reference path 60 at the rearward distance of d_{T}.

Vehicle orientation with respect to the lane reference path tangent at the forward distance d_{F} is represented by angle θ_{F}, and vehicle orientation with respect to the lane reference path tangent at the rearward distance d_{T} is represented by angle θ_{T}.

In addition to the elements and dimensions shown in the bicycle model 30 and the control model 40, the following symbols must also be defined: m=Total mass of the host vehicle 50; I_{ω}=Total inertia of the host vehicle 50 around the center of gravity point 56; l=Distance between the front and rear axles, (l=l_{F}+l_{T}); and c_{F}, c_{T}=Cornering stiffness of the front and rear tires, 52 and 54, respectively.

A linearized bicycle state-space model of the lateral vehicle dynamics can be written as:

$$[ \begin{matrix}{\dot{v}}_{yH} \\ {\dot{ω}}_{H}\end{matrix} ] = [ \begin{matrix}- \frac{{c}_{F} + {c}_{T}}{{mv}_{xH}} & \frac{{c}_{T} {l}_{T} - {c}_{F} {l}_{F}}{{mv}_{xH}} - {v}_{xH} \\ \frac{- {l}_{F} {c}_{F} + {l}_{T} {c}_{T}}{{I}_{ω} {v}_{xH}} & - \frac{{l}_{F}^{2} {c}_{F} + {l}_{T}^{2} {c}_{T}}{{I}_{ω} {v}_{xH}}\end{matrix} ] [ \begin{matrix}{v}_{yH} \\ {ω}_{H}\end{matrix} ] + [ \begin{matrix}\frac{{c}_{F}}{m} \\ \frac{{l}_{F} {c}_{F}}{{I}_{ω}}\end{matrix} ] {δ}_{F} \qquad ( 1 )$$

The state-space equations capturing the evolution of the forward-view camera measurements due to the motion of the host vehicle 50 and changes in the road geometry are:

Δ\dot{y}^{F}=v_{xH}θ_{F}−v_{yH}−ω_{H}d_{F} (2)

\dot{θ}_{F}=v_{xH}κ−ω_{H} (3)

Similarly, the state-space equations capturing the evolution of the rear-view camera measurements due to the motion of the host vehicle 50 and changes in the road geometry are:

Δ\dot{y}_{T}=v_{xH}θ_{T}−v_{yH}+ω_{H}d_{T} (4)

\dot{θ}_{T}=v_{xH}κ−ω_{H} (5)

It is assumed that the leading target vehicle 80 is following the centerline of the lane reference path 60, thus the state-space equations capturing the evolution of the radar measurements due to the motion of the host vehicle 50 and changes in the road geometry are:

\dot{Y}_{O}=v_{xH}θ_{O}−v_{yH}−ω_{H}X_{O} (6)

\dot{θ}_{O}=v_{xH}θ−ω_{H} (7)

The vehicle lateral dynamics, front camera dynamics, rear camera dynamics, and leading target vehicle dynamics described in Equations (1)-(7) can then be combined into a single dynamic system of the form:

$$[ \begin{matrix}{\dot{v}}_{yH} \\ {\dot{ω}}_{H} \\ Δ {\dot{y}}_{F} \\ {\dot{θ}}_{F} \\ Δ {\dot{y}}_{T} \\ {\dot{θ}}_{T} \\ {\dot{Y}}_{O} \\ {\dot{θ}}_{O}\end{matrix} ] = [ \begin{matrix}- \frac{{c}_{F} + {c}_{T}}{{mv}_{xH}} & \frac{{c}_{T} {l}_{T} - {c}_{F} {l}_{F}}{{mv}_{xH}} - {v}_{xH} & 0 & 0 & 0 & 0 & 0 & 0 \\ \frac{- {l}_{F} {c}_{F} + {l}_{T} {c}_{T}}{{I}_{ω} {v}_{xH}} & - \frac{{l}_{F}^{2} {c}_{F} + {l}_{t}^{2} {c}_{T}}{{I}_{ω} {v}_{xH}} & 0 & 0 & 0 & 0 & 0 & 0 \\ - 1 & - {d}_{F} & 0 & {v}_{xH} & 0 & 0 & 0 & 0 \\ 0 & - 1 & 0 & 0 & 0 & 0 & 0 & 0 \\ - 1 & {d}_{T} & 0 & 0 & 0 & {v}_{xH} & 0 & 0 \\ 0 & - 1 & 0 & 0 & 0 & 0 & 0 & 0 \\ - 1 & - {X}_{O} & 0 & 0 & 0 & 0 & 0 & {v}_{xH} \\ 0 & - 1 & 0 & 0 & 0 & 0 & 0 & 0\end{matrix} ] [ \begin{matrix}{v}_{yH} \\ {ω}_{H} \\ Δ {y}_{F} \\ {θ}_{F} \\ Δ {y}_{T} \\ {θ}_{T} \\ {Y}_{O} \\ {θ}_{O}\end{matrix} ] + [ \begin{matrix}\frac{{c}_{F}}{m} \\ \frac{{l}_{F} {c}_{F}}{{I}_{ω}} \\ 0 \\ 0 \\ 0 \\ 0 \\ 0 \\ 0\end{matrix} ] {δ}_{F} + [ \begin{matrix}0 \\ 0 \\ 0 \\ {v}_{xH} κ \\ 0 \\ {v}_{xH} κ \\ 0 \\ {v}_{xH} κ\end{matrix} ]$$

or in short as:

\dot{x}=ƒ(x)+g(δ_{F}) (8)

Let y=[\dot{ω}_{H} Δ\dot{y}_{F} \dot{θ}_{F} Δ\dot{y}_{T} \dot{θ}_{T} \dot{Y}_{O} \dot{θ}_{O}]^{T} denote the output of the dynamic system, observed by the yaw rate sensor, the forward-view camera 12, the rear-view camera 14, and the leading vehicle position system 16. The observation equation can be written as y=o(x).

Referring to the lane reference path 60 and the vehicle path 100 of FIG. 3, the goal of the lateral control module 20 is to track the roadway by regulating the lateral differences between the lane reference path 60 (i.e., Δy_{F}, Δy_{T} and Y_{O}) and the vehicle path 100 (i.e., α_{F}, α_{T}, and α_{O}) at distances of d_{F}, d_{T}, and X_{O}, measured by the forward-view camera 12, the rear-view camera 14, and the leading vehicle position system 16, respectively. Namely, the control objective is to minimize:

J=w_{F}ε_{F}−w_{T}ε_{T}+w_{O}ε_{O} (9)

where ε_{F}=εy_{F}−α_{F}, ε_{T}=Δy_{T}−α_{T}, and ε_{O}=Y_{O}−α_{O}; and w_{F}, w_{T}, and w_{O} are normalized positive weights such that w_{F}+w_{T}+w_{O}=1.

Equation (9) can then be written as:

J=h(x) (10)

Feedback linearization is a common approach used in controlling nonlinear system. The approach involves coming up with a transformation of the nonlinear system into an equivalent linear system through a change of variables and a suitable control input. The application of this technique to the bicycle model 30 is not linearization since the bicycle model 30 is already linear. But this technique can be applied to render the bicycle model 30 independent of the host vehicle longitudinal velocity v_{xH}.

The control law required to linearize the system expressed in Equations (8) and (10) by differentiating Equation (10) twice with respect to time is as follows:

$${δ}_{F} = \frac{1}{{L}_{g} {L}_{f}^{2} h ( x )} ( - {L}_{f}^{2} h ( x ) + u ) \qquad ( 11 )$$

where Lⁱ_{f} denotes the i-th Lie derivative along function ƒ. A Lie derivative evaluates the change of one vector field along the flow of another vector field, as is known to those skilled in the art of mathematics.

Employing this control law yields a second order equation of the form \ddot{J}=u. Let z₁=J. The resulting simplified dynamic system can be expressed as:

ż₁=z₂

ż₂=u (12)

Using the following state feedback control law:

u=−k₁z₁−k₂z₂ (13)

the second order system Equation (12) can be written as ż=Az, with

$$A = [ \begin{matrix}0 & 1 \\ {k}_{1} & {k}_{2}\end{matrix} ] .$$

Therefore, with appropriate choice of k₁ and k₂, a stable lane tracking system can be designed with the eigenvector of A in the open left half of the complex plane.

As shown in FIG. 1, the digital map 18 provides input to the lateral control module 20, including an estimate of the lane curvature κ, which can be used as part of a feed-forward control strategy. By letting [\dot{v}_{yH} \dot{ω}_{H} Δ\dot{y}_{F} \dot{θ}_{F}]^{T}=0, the steering input, δ_{fwd}, that tracks a lane curvature κ can be computed from Equations (1)-(3) as:

$${δ}_{fwd} = κ ( l - \frac{( {l}_{F} {c}_{F} - {l}_{T} {c}_{T} ) {v}_{xH}^{2} m}{{c}_{T} {c}_{F} l} ) \qquad ( 14 )$$

This feed-forward component of Equation (14) can be added to the above derived control law in Equations (11) and (13) to improve the transient behavior of the host vehicle 50 when entering and exiting curves.

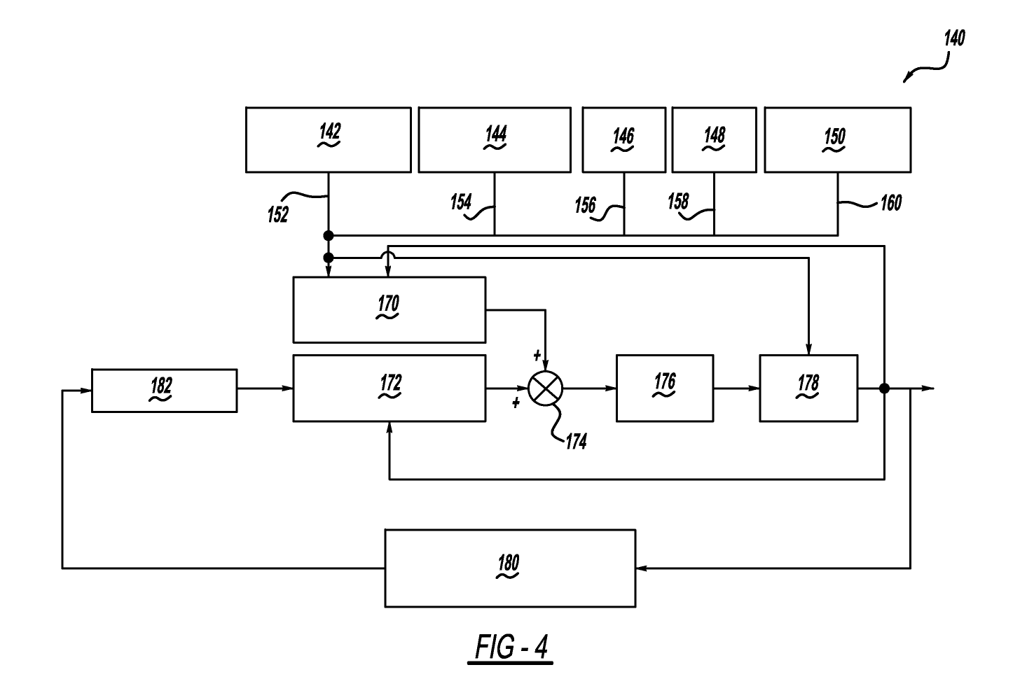

FIG. 4 is a control block diagram 140 which shows how the vehicle lateral control strategy described above is implemented. The steps in the control method are outlined as follows:
1) At box 142, the digital map 18 provides an estimate of the lane curvature κ on line 152.
2) At box 144, vehicle dynamics sensors provide the vehicle forward velocity v_{xH} and yaw rate ω_{H} measurements on line 154.
3) At box 146, the forward-view camera 12 provides measurements of the lane orientation θ_{F}, the lateral displacement Δy_{F}, and the longitudinal distance where the measurement is taken d_{F}, on line 156.
4) At box 148, the rear-view camera 14 provides measurements of the lane orientation θ_{T}, the lateral displacement Δy_{T}, and the longitudinal distance where the measurement is taken d_{T}, on line 158.
5) At box 150, the leading vehicle position system 16 provides leading target vehicle position, i.e., the longitudinal offset X_{O}, the lateral offset Y_{O}, and the heading θ_{O}, on line 160.
6) The inputs on the lines 152-160 are provided to box 170, where the feed-forward term δ_{fwd} is computed as in Equation (14).
7) At box 172, the feedback linearization term δ_{F}, is computed as in Equation (11).
8) At summing junction 174, the feed-forward term δ_{fwd} and the feedback linearization term δ_{F}, are added together, and sent to a steering actuator (electric power steering, or other type system) in the host vehicle 50 at box 176.
9) At box 178, an Observer module estimates the vehicle's state variables using a Kalman filter, with the data on the lines 152-160 and the vehicle's response as inputs, using Equation (8) and y=o(x).
10) At box 180, a variable change module computes z₁ and z₂ using Equations (10) and (12).
11) At box 182, the feedback term u is computed for the linearized dynamic system using Equation (12).

Some examples are provided to further explain the operation of the control method described above. In the best case scenario, measurements from all three external sensors are available; that is, rearward lane boundary information from the rear-view camera 14, forward lane boundary information from the forward-view camera 12, and leading vehicle information from the leading vehicle position system 16. In such a case, the weight parameters in Equation (9) are defined to be proportional to the quality of the measurement (i.e., signal-noise ratio, or variance of the estimates) returned by the corresponding sensors. For example, let measurement variances of the forward-view camera 12, the rear-view camera 14, and the leading vehicle position system 16 be σ_{F}, σ_{T}, and σ_{O}, respectively. Then the corresponding weights are computed as:

$${w}_{F} = C {e}^{- \frac{{σ}_{F}^{2}}{W}} , {w}_{T} = C {e}^{- \frac{{σ}_{T}^{2}}{W}} , {w}_{O} = C {e}^{- \frac{{σ}_{O}^{2}}{W}} \qquad ( 15 )$$

where C is the normalization parameter such that w_{F}+w_{T}+w_{O}=1, and W is a bandwidth parameter chosen by the designer.

In a situation where the leading target vehicle 80 blocks the view of the forward-view camera 12, such that little or no forward lane boundary information is available, the weight parameters of Equation (9) would be tuned by decreasing the value of w_{F} (possibly to zero), and increasing the values of w_{T} and w_{O}. Similarly, in a situation where there is no suitable leading target vehicle 80, the value of w_{O} would be set to zero, and the values of w_{F} and w_{T} would be increased. Finally, in a situation where a low-angle sun or inclement weather obscures the image from the forward-view camera 12, such that no forward lane boundary information is available, the weight parameters of Equation (9) would be tuned by setting the value of w_{F} to zero, and increasing the values of w_{T} and w_{O}.

Using the control method described above, a robust vehicle lateral control system can be implemented. By directly using front and rear camera images as input, along with other indicators of road curvature, the lateral control system can provide more reliable and stable performance than lateral control systems which do not use as many sources of input.

Another approach to vehicular lateral control can be achieved by first combining the data from the forward-view camera 12 and the rear-view camera 14 in a data fusion module, and then using the resultant lane curvature and displacement information from the fusion module in a lateral control module.

FIG. 5 is a block diagram of a system 200 for vehicle lateral control using a 2-camera lane fusion approach. Like the system 10 shown in FIG. 1, the system 200 uses data from the forward-view camera 12, the rear-view camera 14, the leading vehicle position system 16, and the digital map 18. However, unlike the system 10 which uses the inputs directly in the lateral control module 20, the system 200 first combines the inputs in a data fusion module 210. The outputs of the data fusion module 210, including roadway curvature, and the vehicle's displacement and orientation relative to lane boundaries, are then provided to a vehicle lateral control module 220. The outputs of the data fusion module 210 may also be used in applications other than a lateral control system, such as a lane departure warning system.

Two methods of performing lane data fusion will be discussed below. In this discussion, many of the variables and dimensions from FIGS. 2 and 3 will be referenced.

A traditional lane information system with lane departure warning typically includes the forward-view camera 12 that can measure the vehicle orientation with respect to the tangent of the lane θ_{F} at the front, the front lateral displacement Δy_{F} at the front bumper, and the lane curvature κ, where the distance d_{F} is defined as the distance from the center of gravity point 56 to the front bumper of the host vehicle 50. Besides the functionality providing backup assistance, the rear-view camera 14 can offer additional lane sensing measurements; the vehicle orientation with respect to the tangent of the lane θ_{T} at the rear, and the rear lateral displacement Δy_{T} at the rear bumper, where the distance d_{T} is defined as the distance from the center of gravity point 56 to the rear bumper of the host vehicle 50. The two additional camera measurements, θ_{T} and Δy_{T}, are valuable in design of a robust fusion system for lane sensing. They are especially useful in inclement weather and lighting conditions, such as front low-angle sun, partially snow-covered lane markers, reduced visibility due to fog, and the like, where the quality of images from the forward-view camera 12 would be reduced.

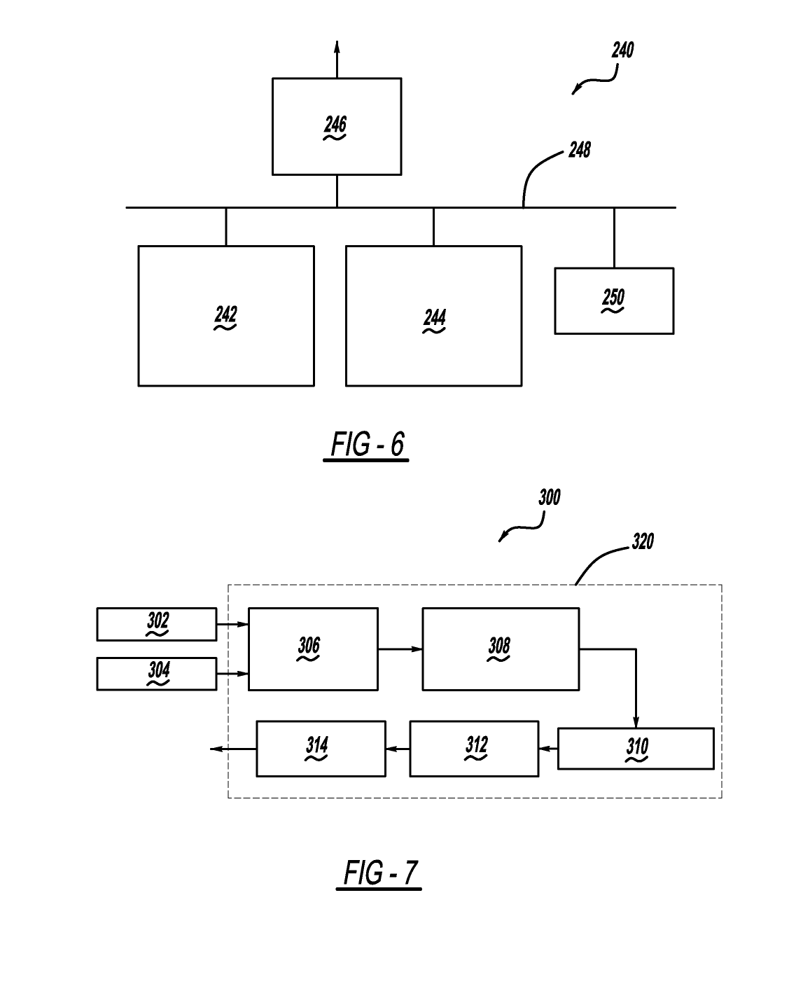

FIG. 6 is a block diagram of a first embodiment of a lane fusion system 240 using input from two cameras. In the system 240, a full-fledged forward lane sensor system 242 and a full-fledged rear lane sensor system 244 each include a camera and a processor, and can detect and track lane boundaries at their respective ends of the host vehicle 50. The forward lane sensor system 242 and the rear lane sensor system 244 provide their measurements to a lane fusion module 246 which computes enhanced lane boundary and orientation information. The forward lane sensor system 242 sends measurements θ_{F}, Δy_{F}, and κ to the fusion module 246 at a fixed sample rate (e.g., 10 Hz). The rear lane sensor system 244 sends measurements θ_{T} and Δy_{T} at the same fixed sample rate. The forward lane sensor system 242, the rear lane sensor system 244, and the fusion module 246 are interconnected by a serial network 248, which may use the Control Area Network (CAN) or other protocol.

The fusion module 246 takes inputs from both the front and rear lane sensor systems 242 and 244, and vehicle dynamic sensors 250, and outputs the enhanced lane information: vehicle orientation with respect to the tangent of the lane (θ), displacement of the front bumper center to the lane boundaries (Δy), and the lane curvature (κ). As mentioned previously, the lane information could be used by various downstream applications.

Let the measurements from the vehicle dynamic sensors 250 include vehicle speed (v_{H}) and yaw rate (ω_{H}). Then the following Kalman filter is designed to fuse the information from both the front and rear lane sensor systems 242 and 244.

Let the state variables be s=(κ, θ, Δy, φ_{F}, φ_{T}), where κ, θ and Δy are defined as above; and φ_{F} and φ_{T}, are the azimuth misalignment of the front and rear lane sensor systems 242 and 244, respectively.

The state dynamic equation is written as:

κ′=κ+v_{κ}

θ′=θ−ω_{H}ΔT+κv_{H}ΔT+v_{θ}

Δy′=Δy+v_{H}ΔTθ+v_{Δy}

φ′_{F}=φ_{F}

φ′_{R}=φ_{R} (16)

or in short as:

s′=Fs+u+Gv (17)

where v=(v_{κ}, v_{θ}, v_{Δy})^{T} denotes a zero-mean Gaussian white noise vector modeling the uncertainty of the state dynamics model;

$$F = [ \begin{matrix}1 & 0 & 0 & 0 & 0 \\ {v}_{H} Δ T & 1 & 0 & 0 & 0 \\ 0 & {v}_{H} Δ T & 1 & 0 & 0 \\ 0 & 0 & 0 & 1 & 0 \\ 0 & 0 & 0 & 0 & 1\end{matrix} ] , u = {[ \begin{matrix}0 & - {ω}_{H} Δ T & 0 & 0 & 0\end{matrix} ]}^{T} , and$$

$$G = [ \begin{matrix}1 & 0 & 0 & 0 & 0 \\ 0 & 1 & 0 & 0 & 0 \\ 0 & 0 & 1 & 0 & 0 \\ 0 & 0 & 0 & 0 & 0 \\ 0 & 0 & 0 & 0 & 0\end{matrix} ] .$$

The measurement model can be written as:

θ_{F}=θ+φ_{F}+w_{θ}_{_{F}}

Δy_{F}=Δy+w_{Δy}_{_{F}}

κ_{F}=κ+w_{κ}

θ_{T}=θ+φ_{T}+w_{θ}_{_{T}}

Δy_{T}=Δy+w_{Δy}_{_{T}} (18)

or in short as:

o=Hs+w (19)

where

$$H = [ \begin{matrix}0 & 1 & 0 & 1 & 0 \\ 0 & 0 & 1 & 0 & 0 \\ 1 & 0 & 0 & 0 & 0 \\ 0 & 1 & 0 & 0 & 1 \\ 0 & 0 & 1 & 0 & 0\end{matrix} ] , o = {[ \begin{matrix}{θ}_{F} & Δ {y}_{F} & {κ}_{F} & {θ}_{T} & Δ {y}_{T}\end{matrix} ]}^{T} ,$$

and w=[w_{θ}_{_{F}} w_{Δy}_{_{F}} w_{κ}w_{θ}_{_{T}} w_{Δy}_{_{T}}]^{T} is a zero-mean Gaussian white noise vector modeling the quality of the measurements from the front and rear lane sensor systems 242 and 244.

In summary, the following Kalman filtering procedure jointly estimates the misalignment angles and the lane parameters:
1) Randomly choose small numbers to initialize the misalignment parameters φ_{F}(0) and φ_{T}(0); combining the misalignment parameters with the first measurement from the front lane sensor 242 yields s(0)=(κ_{F}(0), θ_{F} (0), Δy_{F} (0), φ_{F}(0), φ_{T}(0))^{T}, and a covariance matrix P(0) is chosen for s(0).
2) When the new measurement at time instant t arrives, the previous state vector is written as s(t−1); the predicted state at time instant t can be written as \tilde{s}(t)=Fs(t−1)+u(t), and the covariance matrix \tilde{P}(t)=P(t−1)+GQG^{T}, where Q is the covariance matrix of the noise vector v.
3) Let the measurement at time instant t be o; thus the updated state vector at time instant t is:

e=o−h(\tilde{s}(t))

S=H\tilde{P}(t)H^{T}+R

K=\tilde{P}(t)H^{T}S⁻¹

\tilde{s}(t)=\tilde{s}(t)+Ke

P(t)=(I−KHₜ)\tilde{P}(t)
where R is the covariance matrix.
4) Output \tilde{s}(t) as the fusion output.
5) Go to Step 2.

Using the above procedure, the fusion module 246 of the system 240 computes a combined set of lane parameters for the host vehicle 50, while simultaneously determining the misalignment parameters for the front and rear lane sensor systems 242 and 244.

FIG. 7 is a block diagram of a second embodiment of a lane fusion system 300 using input from two cameras. The system 300 does not include full-fledged lane sensor systems at the front and rear. Instead, the system 300 includes a forward-view camera 302 and a rear-view camera 304. The cameras 302 and 304 only capture images and send them to a fusion module 320, which combines both images together, detects and tracks the lane markers.

Images from the forward-view and rear-view cameras 302 and 304, respectively, are provided to box 306 to find local high intensity regions. The key idea of the box 306 is to find stable local high-intensity regions in different spatial scales. The algorithm begins with building a Gaussian pyramid. At each pyramid scale, the image is subtracted by the enlarged coarse-level image, which is further blurred. Then the local maximum finding operation is applied to the difference images at different scales, and all maxima whose height is less than a threshold h are suppressed. Thus the binary images of possible lane markers are derived at the box 306.

At box 308, the detected pixels of curbs and stripes are projected onto ground plane in the vehicle coordinate system based on the camera calibration parameters. At box 310, point clouds of the projected pixels from the box 308 are first clustered based on the similarity measure (distance). Close pixels are clustered into a single component. Then the components are classified based on their geometry shape. Components whose shape matches with curbs and lane stripes are selected, and then line fitting and arc fitting procedures are applied to fit the stripe candidates. The components whose shape do not match with a line or an arc are discarded.

At box 312, the fitted stripes in vehicle coordinate system are then linked into a lane boundary. At box 314, lane information is tracked and output. This includes: monitoring the fitted stripes and data from vehicle dynamic sensors; tracking the lane boundary; and estimating lane information, including the lane curvature (κ), the vehicle orientation with respect to the tangent of the lane (θ), and the displacement of the front bumper center to the lane boundaries (Δy). Details of the algorithms used in the boxes 308-314 are given below.

The projection algorithm of the box 308 requires the following camera intrinsic parameters:
Focal length: The focal length in pixels, [ƒᵤ, ƒᵥ];
Optical center: [cᵤ, cᵥ];
Skew coefficient: The skew coefficient defining the angle between the x and y pixel axes is stored in the scalar α_{c};
Distortions: The image distortion coefficients (radial and tangential distortions) are stored in the vector k_{c}=(k₁, k₂, k₃, k₄, p₁, p₂), where (k₁, k₂, k₃, k₄) is radial distortion coefficients and (p₁, p₂) is tangential coefficients;
   and camera extrinsic parameters:
Translation vector T;
Rotation matrix R;
   The camera extrinsic parameters are estimated through a camera calibration process, many of which are known in the art, and which need not be discussed here.

An iterative procedure used to remove the distortion is outlined below. The input includes a set of pixels S={(uᵢ, vᵢ)|i=1, . . . , N} and the above-defined camera intrinsic parameters. The output is the rectified set of pixels S′={(u′ᵢ, v′ᵢ)|i=1, . . . , N}. The procedure is as follows:

1) For each pixel sᵢ=(uᵢ, vᵢ), i=1, . . . , N;

2) Iteratively execute the following steps 20 times:

$$a . Let u = [ \begin{matrix}{u}_{i} \\ {v}_{i}\end{matrix} ] and r = ‖ x ‖ .$$

b. Compute radial correction:

k_{rad}=1+k₁r+k₂r²+k₃r³+k₄r⁴.
c. Compute tangential correction:

$$Δ u = [ \begin{matrix}2 {p}_{1} {u}_{i} {v}_{i} + {p}_{2} ( {r}^{2} + 2 {u}_{i}^{2} ) \\ {p}_{1} ( {r}^{2} + 2 {v}_{i}^{2} ) + 2 {p}_{2} {u}_{i} {v}_{i}\end{matrix} ] .$$

Correct the pixel u=(u+Δu)/k_{rad}.

3) Output u as the final corrected pixel (u′ᵢ, v′ᵢ).

After the above rectification, or distortion removing process, the following transformation can be applied. The input includes a set of rectified pixels S′={(u′ᵢ, v′ᵢ)|i=1, . . . , N} and the camera extrinsic parameters described above. The output is the detected lane marker points projected onto the vehicle frame: X={(xᵢ,yᵢ)|i=1, . . . N}. The transformation process is as follows:
1) For each pixel sᵢ=(uᵢ, vᵢ), i=1, . . . , N;

$$a . Let u = [ \begin{matrix}{u}_{i}^{′} \\ {v}_{i}^{′}\end{matrix} ] and {K}_{K} = [ \begin{matrix}{f}_{u} & {α}_{c} {f}_{u} & {c}_{u} \\ 0 & {f}_{v} & {c}_{v} \\ 0 & 0 & 1\end{matrix} ] .$$

b. Compute P=Kₖ[R T].
c. Let H=[p₁ p₂ p₄] where pⱼ, j=1, . . . , 4 is the column vector.
d. Compute z=H⁻¹u.
2) Output z as the projected pixel (xᵢ,yₗ) in ground plane in vehicle frame.

The above rectification and transformation procedures are applied at the box 308 to provide a set of highlighted pixels, that is, points that are candidate curb or lane stripe points, in the vehicle coordinate frame. Then, at the box 310, the pixels or points are clustered together into curbs and lane stripes. Given the lane marker pixel set

$$X = \{ {z}_{i} \vert {z}_{i} = [ \begin{matrix}{x}_{i} \\ {y}_{i}\end{matrix} ] , i = 1 , … N \} ,$$

the pixels are first clustered into stripes and then the stripes are fit into line or arc segments.

First, in order to cluster adjacent pixels into a stripe, a similarity graph G=(V,E) is constructed where the vertex set is defined as the pixels on ground, i.e., V={zᵢ|i=1, . . . N} and the edge set E is defined as a set of pixel pairs if each pixel pair's distance on the ground plane is less than a threshold (Tₛₑₚ), or each pixel pair is in 8-neighbor proximity of each other in the image plane, i.e., E={(zᵢ,zⱼ)|∥zᵢ−zⱼ∥<Tₛₑₚ V Neighbor(sᵢ,sⱼ)}, where sᵢ and sⱼ are the corresponding locations in the image plane; and Neighbor(sᵢ,sⱼ) is true if sᵢ and Sⱼ are in 8-neighbor proximity of each other. In this clustering methodology, 8-neighbor proximity means that a second pixel is one of the 8 nearest neighbors (immediately left, right, above, below, above-left, above-right, below-left, or below-right) of a first pixel, in an approximately rectangular grid of pixels.

Next a depth-first search (DFS) strategy is applied to partition the graph into connected components: {X₁, . . . , X_{c}}. Then each of the clustered stripes is fitted with a line or an arc.

Let zᵢ=(xᵢ,yᵢ), i=1, . . . , N_{c} be a pixel in a detected stripe. The stripe can be fitted by a line parametric equation (Ax+By=d, such that A²+B²=1). The parameters A, B and d can be estimated via least-squares, such as minimizing:

$${‖ D β ‖}^{2} , D = ( \begin{matrix}{x}_{1} & {y}_{1} & 1 \\ {x}_{2} & {y}_{2} & 1 \\ ⋮ & ⋮ & ⋮ \\ {x}_{{N}_{c}} & {y}_{{N}_{c}} & 1\end{matrix} ) , β = ( \begin{matrix}A \\ B \\ d\end{matrix} ) \qquad ( 20 )$$

which can be solved by finding the eigenvector of X with the smallest eigenvalue μₘ:

Dβ=μₘβ (21)

The fitting residue is defined as e=μₘ.

The width W and length L of the stripe are computed as:

$$W = {max}_{i} ( {z}_{i}^{T} n ) - {min}_{i} ( {z}_{i}^{T} n ) , L = {max}_{i} ( {z}_{i}^{T} t ) - {min}_{i} ( {z}_{i}^{T} t ) \qquad ( 22 )$$

respectively, where n and t are the normal and tangential vectors (unit length) of the line segment, i.e.,

$$n = [ \frac{A}{r} \frac{B}{r} ] and {d}^{′} = \frac{d}{r}$$

with r=\sqrt{A²+B²}. Then t is derived by rotating n by 90 degrees.

The two endpoints of the stripe are:

$${e}_{s} = {z}_{m} - ( {n}^{T} {z}_{m} - {d}^{′} ) n \\ {e}_{e} = {z}_{M} - ( {n}^{T} {z}_{M} - {d}^{′} ) n \\ where indices m = {arg min}_{i = 1 , … , {N}_{c}} ( {z}_{i}^{T} t ) and M = {arg max}_{i = 1 , … , {N}_{c}} ( {z}_{i}^{T} t ) . \qquad ( 23 )$$

The orientation (angle) of the stripe is φ=atan 2(A,B).

If the residue of line fitting is larger than a threshold, the stripe is fit again using a circle parametric equation (x²+y²+a₁x+a₂y+a₃=0). The parameters a₁, a₂, and a₃ can be estimated via least-squares, such as minimizing:

$${‖ C α - b ‖}^{2} , C = [ \begin{matrix}{x}_{1} & {y}_{1} & 1 \\ {x}_{2} & {y}_{2} & 1 \\ ⋮ & ⋮ & ⋮ \\ {x}_{{N}_{c}} & {y}_{{N}_{c}} & 1\end{matrix} ] , \\ b = [ \begin{matrix}- ( {x}_{1}^{2} + {y}_{1}^{2} ) \\ - ( {x}_{2}^{2} + {y}_{2}^{2} ) \\ ⋮ \\ - ( {x}_{{N}_{c}}^{2} + {y}_{{N}_{c}}^{2} )\end{matrix} ] , \\ α = [ \begin{matrix}{a}_{1} \\ {a}_{2} \\ {a}_{3}\end{matrix} ] \qquad ( 24 )$$

with respect to α.

The solution of the above least squares is α=(C^{T}C)⁻¹C^{T}b. The radius and center of the fitted circle can be written as:

$$R = ( {a}_{1}^{2} + {a}_{2}^{2} ) / 4 - {a}_{3} \\ {x}_{c} = - \frac{{a}_{1}}{2} \\ {y}_{c} = - \frac{{a}_{2}}{2} \qquad ( 25 )$$

respectively.

The two endpoints of the fitted arc can be computed as:

eₛ=[x_{c}+R cos φₘ y_{c}+R sin φₘ]^{T}

eₑ=[x_{c}+R cos φ_{M} y_{c}+R sin φ_{M}]^{T} (26)

and the stripe's orientation (angle) at the endpoints are φₛ=φₘ and φₑ=φ_{M}, where the indices

$$m = {arg min}_{i = 1 , … , {N}_{c}} ( a tan ( {y}_{i} - {y}_{c} , {x}_{i} - {x}_{c} ) ) and$$

$$M = {arg max}_{i = 1 , … , {N}_{c}} ( a tan ( {y}_{i} - {y}_{c} , {x}_{i} - {x}_{c} ) ) .$$

The width W and length L of the stripe are computed as follows:

W=max(∥zᵢ−c∥)−min(∥zᵢ−c∥) (27)

and

L=∥eₛ−eₑ∥ (28)

respectively, where c=[x_{c} y_{c}]^{T} denotes the center of the circle.

In summary, the output of the box 310 is a list of stripes fitted with line segments with the following parameters; normal vector (n), distance to the origin (d′), width (W), length (L), orientation (φ), and start points (eₛ); or arc segments with the following parameters; the center of the circle (c), radius (R), width (W), length (L), and two end points' positions (eₛ and eₑ).

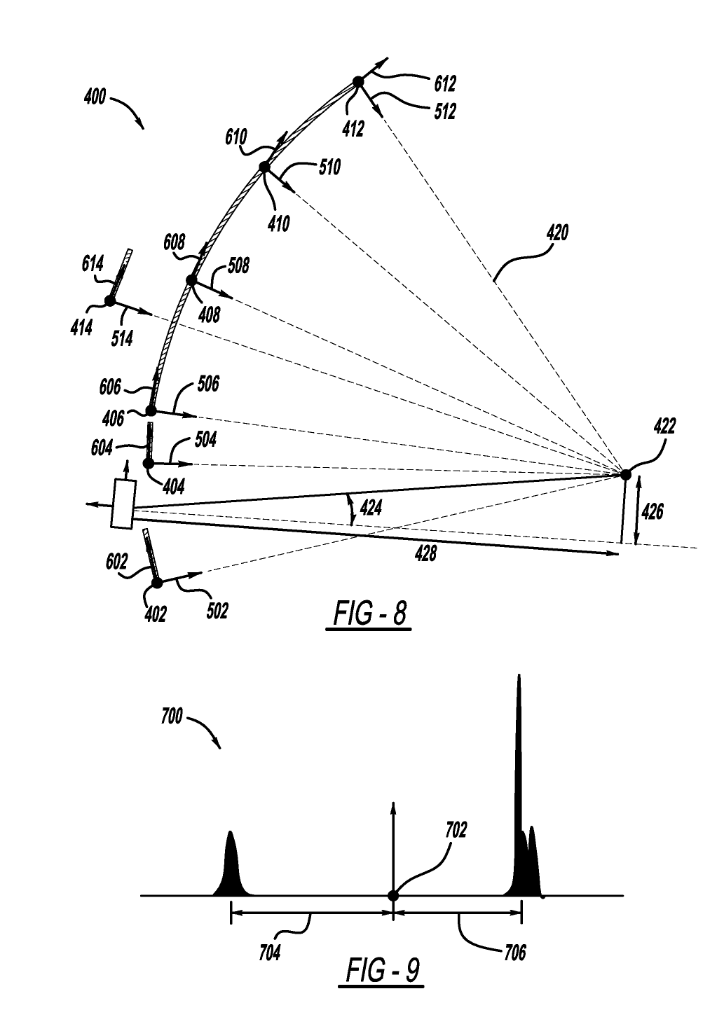

FIG. 8 is a diagram 400 which shows an example of lane stripe representation for a scenario where the following have been detected: line segment #1 represented by end point 402 and normal vector 502, line segment #2 (404, 504), line segment #3 (414, 514), and arc segment with radius 420, center (c) 422, first end point 406, and second end point 412. The following steps are used at the box 312 to link the stripes into left and right lane boundaries.

First, any stripe whose aspect ratio (L/W) is less than a threshold is removed. Only slim stripes are kept for further processing. Then long arc or line segments are broken down into short segments, and each segment is represented by a start end point (e) and a tangential vector (t). For example, in the diagram 400, the start end point and tangential vector for line segment #1 are represented as (402, 602); and the long arc is broken up into four end points: (406, 606), (408, 608), (410, 610), and (412, 612).

To estimate the overall lane geometry information at the box 314 (i.e., the lane curvature ic, the vehicle's orientation with respect to the lane tangent θ, and the displacement to lane boundaries Δy), an estimate is needed for the position of center c.

Given a set of stripe segments {(eₖ,tₖ)|k=1, . . . , K}. For each segment, (eₖ,tₖ) there is a normal (dashed lines in the diagram 400) passing through c, i.e., t^{T}ₖ(c−eₖ)=0. Let tₖ=(tₓₖ, t_{yk}). Therefore, finding c is equivalent to minimizing the following least squares:

$$‖ Ec - γ ‖ , E = [ \begin{matrix}{t}_{x 1} & {t}_{y 1} \\ {t}_{x 2} & {t}_{y 2} \\ ⋮ & ⋮ \\ {t}_{x K} & {t}_{y K}\end{matrix} ] , γ = [ \begin{matrix}{t}_{1}^{T} {e}_{1} \\ {t}_{2}^{T} {e}_{2} \\ ⋮ \\ {t}_{K}^{T} {e}_{K}\end{matrix} ] \qquad ( 29 )$$

The solution of the above least squares is c=(E^{T}E)⁻¹E^{T}γ. The curvature of the lane can be written as:

$$κ = \{ \begin{matrix}\frac{1}{‖ c ‖} & if c is on left side \\ - \frac{1}{‖ c ‖} & otherwise .\end{matrix} \qquad ( 30 )$$

The vehicle's orientation with respect to the lane tangent can be computed as:

θ=atan 2(cₓ,c_{y}) (31)

where cₓ is shown as dimension 426 and c_{y} is shown as dimension 428 in the diagram 400.

FIG. 9 is a histogram 700 which shows an example of how the displacement to the lane boundaries can be computed. Let {zⱼ|j=1, . . . , M} denote the pixels of detected lane stripes. The histogram 700 is constructed which graphs the distance to the center c for all of these pixels (i.e., dⱼ=∥zⱼ−c∥, j=1, . . . , M). The histogram 700 has an origin point 702.

Displacement to left lane boundary is distance 704 from the origin point 702 to the left local peak in the histogram 700, while displacement to right lane boundary y_{R} is distance 706 from the origin point 702 to the right local peak.

Equations (29)-(31) estimate the lane using data from a single frame from the cameras 302 and 304. The method can be extended to include tracking and data from vehicle dynamic sensors. Two such methods are proposed. For both methods, the state variables are defined as s=(κ, θ, Δy) where the variables are defined as the lane curvature (κ), vehicle orientation with respect to the tangent of the lane (θ), and displacements to the lane boundaries (Δy), respectively. Let the vehicle speed (v_{H}) and yaw rate (ω_{H}) denote measurements from the vehicle dynamic sensors.

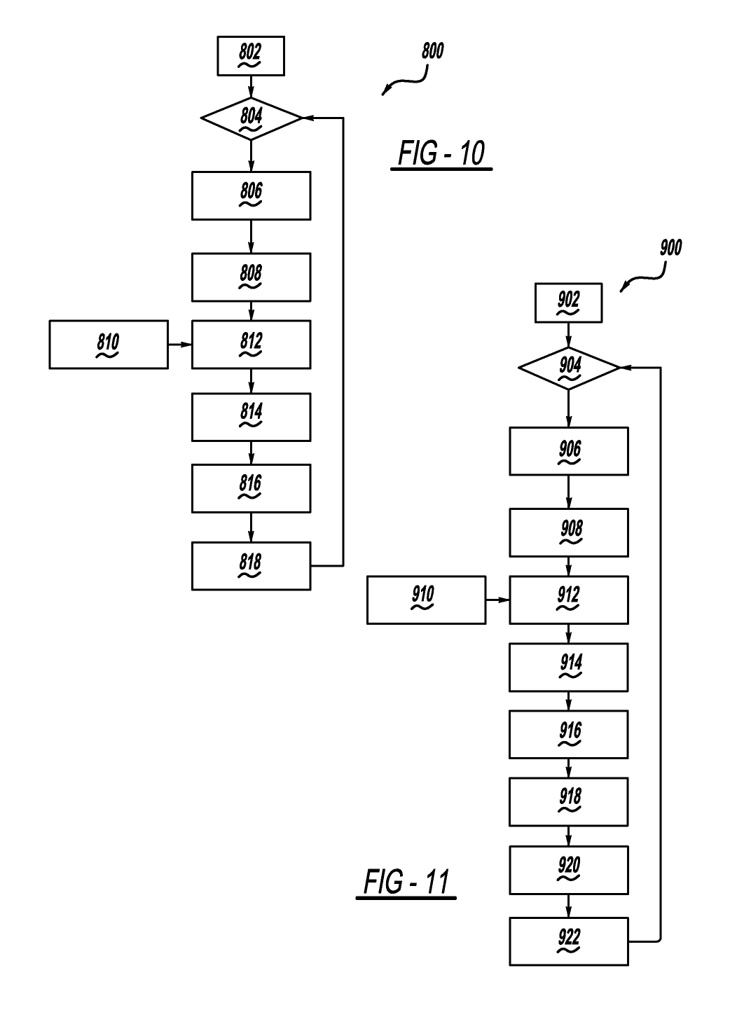

For the first method, a Kalman tracking procedure is used to estimate the lane parameters. FIG. 10 is a flow chart diagram 800 of the Kalman tracking method. The steps are as follows:
1) At box 802, initialize the state vector s(0) with first measurement from the system 300 (Equations (29)-(31)), and choose a covariance matrix P(0) for s(0).
2) Wait at decision diamond 804 for new data to arrive; when the new measurement at time instant t arrives, at box 806 write the previous state vector as s(t−1); then at box 808 the predicted state s(t) at time instant t can be written as:

κ′=κ

θ′=θ−ω_{H}ΔT+κv_{H}ΔT

Δy′=Δy+v_{H}ΔTθ

where ΔT is the time increment, and the projected state vector

s′(t)=[κ′ θ′ Δy′].
3) Also at the box 808, the circle center is computed as:

$${c}^{′} = [ \begin{matrix}\frac{1}{{κ}^{′}} sin {θ}^{′} & \frac{1}{{κ}^{′}} cos {θ}^{′}\end{matrix} ] .$$

4) At box 810, the detected stripes (eₖ,tₖ) from the cameras 302 and 304 are provided; then at box 812, a gating operation is performed to identify outliers of the detected stripes, using the following criteria:

$$\frac{\vert {( {e}_{k} - {c}^{′} )}^{T} {t}_{k} \vert}{‖ {e}_{k} - {c}^{′} ‖} < T$$

where T is a threshold value; a stripe will be treated as an outlier if the above is not true.
5) At box 814, compute the current lane geometry information; for all stripes remaining after the gating of the box 812, the least squares are minimized using Equation (29) to find the solution for the updated center ĉ; then κₘ and θₘ are computed through Equations (30)-(31), respectively, and displacements Δyₘ through building the histogram.
6) At box 816, perform a measurement correction; treat κₘ, θₘ, and Δyₘ as the direct measurement of the state variables; the following measurement equations can be written:

θₘ=θ+w_{θ}_{ₘ}

Δyₘ=Δy+w_{Δy}_{ₘ}

κₘ=κ+w_{κ}_{ₘ}
where (w_{θ}_{ₘ} w_{Δy}_{ₘ} w_{κ}_{ₘ})^{T} is a zero-mean white Gaussian noise vector, whose covariance matrix is a function of the residue in the least squares minimization of Equation (29); then a Kalman filter is applied to the obtain the final output s(t) and the corresponding covariance matrix P(t).
7) At box 818, output the updated lane geometry information, and go back to the decision diamond 804.

The Kalman tracking procedure described above and on the flow chart diagram 800 represents the first method for computing lane curvature and vehicle orientation information, using images from the forward-view and rear-view cameras 302 and 304 and data from vehicle dynamics sensors. The second method uses a particle filter. FIG. 11 is a flow chart diagram 900 showing the particle filter method, which uses the following steps to compute the lane parameters:
1) At box 902, initialize the state vector s(0) with a set of particles (random sample of geometry information): {(sᵢ(0), wᵢ)|i=1, . . . , M} and the weight

$${w}_{i} = \frac{1}{M} ,$$

for i=1, . . . , M.
2) Wait at decision diamond 904 for new data to arrive; when the new measurement data at time instant t arrives, for each of the particles, κₘ, θₘ and Δyₘ are calculated using the steps 2) to 5) of the Kalman tracker; that is;
   a. At box 906, write the previous state vector as s(t−1).
   b. At box 908, calculate the predicted state s(t); also compute the circle center c′.
   c. At box 910, provide detected stripes from both cameras; at box 912, perform a gating operation to identify outlier stripes.
   d. At box 914, compute the current lane geometry information using Equations (29)-(31) and the histogram.
3) Then the value of the i-th particle becomes s′ᵢ(t)=(κₘ, θₘ, Δyₘ); let Δᵢ denote the residue of the estimation for the i-th particle; at box 916, compute the new weight of the particle as

$${w}_{i}^{′} = exp ( - \frac{{Δ}_{i}^{2}}{2 σ} ) ,$$

where σ is a predefined constant.
4) At box 918, compute the weighted average of the particle set ŝ(t) as:

ŝ(t)=Σ^{M}ᵢ₌₁sᵢ(t)wᵢ/Σ^{M}ᵢ₌₁wᵢ
and output ŝ(t).
5) At box 920, apply importance re-sampling, a standard statistical procedure, to the updated particle set {(s′ᵢ(t),w′ᵢ)|i=1, . . . , M}; this yields a set of random samples of the updated lane geometry information at box 922.
6) Go to Step 2, the decision diamond 904.

As described above and shown on the flow chart diagrams 800 and 900, either the Kalman filter method or the particle filter method can be used to compute the lane geometry information—the lane curvature x, the vehicle's orientation with respect to the lane tangent 9, and the displacement to lane boundaries Δy—using images from the forward-view and rear-view cameras 302 and 304, and vehicle dynamics sensors, as input. The resultant lane geometry information can be used by downstream applications, such as a lane departure warning system.

The methods and systems disclosed herein, by using the image data available from a rear-view camera, and combining it with image data from a forward-view camera and other sensors, provide more robust capability for lane sensing or lateral control. The two-camera system not only makes use of more input data under normal conditions, but also provides a usable source of image data to allow operation of the system when conditions are unfavorable for forward-view imaging. Vehicle manufacturers and consumers can benefit from these systems, which take advantage of existing rear-view imaging capability in many vehicles to offer improved system performance and reliability, while incurring no new hardware-related costs.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing lateral control of a host vehicle, said method comprising:
providing image data from a forward-view camera onboard the host vehicle;
providing image data from a rear-view camera onboard the host vehicle;
providing data about a roadway that the host vehicle is travelling on from a digital map system;
providing data about a leading vehicle from a leading vehicle position system onboard the host vehicle, where the leading vehicle is a vehicle ahead of the host vehicle on the roadway; and
computing a steering input needed to control the host vehicle to maintain a path on the roadway using the image data from the forward-view camera and the rear-view camera and the data from the digital map system and the leading vehicle position system, and providing the steering input to a steering actuator in the host vehicle.

2. The method of claim 1 wherein providing image data from a forward-view camera includes providing estimates of position and orientation of the host vehicle with respect to the roadway at a location in front of the host vehicle.

3. The method of claim 1 wherein providing image data from a rear-view camera includes providing estimates of position and orientation of the host vehicle with respect to the roadway at a location behind the host vehicle.

4. The method of claim 1 wherein providing data about a leading vehicle includes providing a longitudinal offset, a lateral offset, and a heading angle of the leading vehicle with respect to the host vehicle.

5. The method of claim 1 wherein computing a steering input needed to control the host vehicle includes computing a feed-forward term based on the image data from the cameras, and the data from the digital map system and the leading vehicle position system.

6. The method of claim 1 wherein computing a steering input needed to control the host vehicle includes computing a feedback linearization term based on vehicle dynamic response parameters.

7. A method for providing lateral control of a host vehicle, said method comprising:
providing image data from a forward-view camera onboard the host vehicle;
providing image data from a rear-view camera onboard the host vehicle;
providing data from vehicle dynamics sensors onboard the host vehicle;
providing data about a roadway that the host vehicle is travelling on from a digital map system;
providing data about a leading vehicle from a leading vehicle position system onboard the host vehicle, where the leading vehicle is a vehicle ahead of the host vehicle on the roadway;
computing a steering input needed to control the host vehicle to maintain a path on the roadway using the image data from the forward-view camera and the rear-view camera and the data from the vehicle dynamics sensors, the digital map system, and the leading vehicle position system;
providing the steering input to a steering actuator in the host vehicle; and
estimating a dynamic response of the host vehicle.

8. The method of claim 7 wherein providing image data from a forward-view camera includes providing estimates of position and orientation of the host vehicle with respect to the roadway at a location in front of the host vehicle.

9. The method of claim 7 wherein providing image data from a rear-view camera includes providing estimates of position and orientation of the host vehicle with respect to the roadway at a location behind the host vehicle.

10. The method of claim 7 wherein providing data from vehicle dynamics sensors includes providing a velocity and a yaw rate for the host vehicle.

11. The method of claim 7 wherein providing data about a leading vehicle includes providing a longitudinal offset, a lateral offset, and a heading angle of the leading vehicle with respect to the host vehicle.

12. The method of claim 7 wherein computing a steering input needed to control the host vehicle includes computing a feed-forward term based on the image data from the cameras, and the data from the vehicle dynamics sensors, the digital map system, and the leading vehicle position system.

13. The method of claim 7 wherein computing a steering input needed to control the host vehicle includes computing a feedback linearization term based on the dynamic response of the vehicle.

14. The method of claim 7 wherein estimating a dynamic response of the host vehicle includes using a Kalman filter routine to estimate a set of state variables for the host vehicle.

15. A system for providing lateral control of a host vehicle, said system comprising:
a first camera for capturing images of a forward view from the host vehicle;
a second camera for capturing images of a rear view from the host vehicle;
a plurality of vehicle dynamics sensors onboard the host vehicle for providing data about motion of the host vehicle;
a digital map for providing information about a roadway on which the host vehicle is being driven;
a leading vehicle position sub-system onboard the host vehicle, said leading vehicle position sub-system providing data about the position of a leading vehicle with respect to the host vehicle; and
a processor configured to receive data from the cameras, the vehicle dynamics sensors, the digital map, and the leading vehicle position sub-system, said processor computing a steering input needed to control the host vehicle to maintain a path on the roadway.

16. The system of claim 15 wherein the images from the first camera and the second camera provide data about locations of lane boundaries of the roadway, including curbs and lane stripes.

17. The system of claim 15 wherein the vehicle dynamics sensors include a velocity sensor and a yaw rate sensor.

18. The system of claim 15 wherein the leading vehicle position sub-system provides a longitudinal offset, a lateral offset, and a heading angle of the leading vehicle with respect to the host vehicle.

19. The system of claim 15 wherein the processor includes a module for estimating a dynamic response of the host vehicle using a Kalman filter routine, and using the dynamic response of the host vehicle in a feedback linearization term which is used to compute the steering input.

20. The system of claim 15 wherein the processor also includes a module for calculating a feed-forward term which is used to compute the steering input.
